(19) United States
(12) Patent Application Publication
(10) Pub. No.: US 2009/0006939 A1
(43) Pub. Date: Jan. 1, 2009

(54) TASK-SPECIFIC SPREADSHEET WORKSHEETS

(75) Inventors: Stuart N. DeSpain, Seattle, WA (US); Andrew Ely Ryder, Seattle, WA (US); Joseph F. E. Jones, Redmond, WA (US); Jim Kee Chan, Woodinville, WA (US); Matthew E. David, Sammamish, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/771,893

(22) Filed: Jun. 29, 2007

(51) Int. Cl. G06F 17/00; G06F 3/048

(52) U.S. Cl. 715/217; 715/781

(57) ABSTRACT

A computer-readable medium having computer-executable modules is provided. The medium includes a computer spreadsheet application including a worksheet defining a series of cells arranged in addressable rows and columns. In addition, a sheet definition is provided. The sheet definition includes a set of constraints applied to the worksheet based on a task-specific function defined for the spreadsheet. Users may select a task-specific worksheet in the application which is limited by the set of constraints.

### BACKGROUND

Computerized spreadsheets have become widely used for organizing numerical and textual data. Spreadsheet application programs, such as for example Microsoft® Excel, are executed by a processor to provide the user with a graphical presentation of a spreadsheet, and tools for entering information on the spreadsheet. The spreadsheets may consist of rows and columns of individual cells. The columns can be organized by letter—Columns A, B, C, etc.—and the rows can be organized by number—Rows 1, 2, 3, etc. In this example, each cell is identified by a combination of column letter and row number. Cell “B3,” for instance, is in column B and row 3. The user can organize numerical and/or textual data in the cells of the spreadsheet as desired using the computer's graphical user interface, and can format the numerical and/or textual data so as to be recognized as one of a variety of data classes, including text, dates, currency, integers and/or floating point numbers.

The spreadsheet is a rectangular table or grid of information designed to perform general computational tasks using special relationships between cells in the grid. In a spreadsheet a set of cells is defined with the special relationship to one another.

Generally, when a user starts the application, they are presented with an open sheet—a sheet of uniformly sized rows and columns devoid of formulas, data or formatting. This blank canvas can be somewhat overwhelming to novice users. Cells are essentially useless without any understanding of the formulas and structure required to organize them into task-based programs.

In order to provide novice and intermediate users with a starting point for creating useful worksheets, application providers generally provide the user with templates of commonly used functional sheets, such as financial planning, checkbook sheets, expense reports and the like. The trouble with templates is that users can break the functionality of a template any modification of the template can affect its functionality. If a user inserts a row or column, this may create a problem in the functioning of the spreadsheet. In addition, templates are limited by the available functionality of the spreadsheet.

### SUMMARY

Technology is provided which allows users of a spreadsheet application to create and use task-specific worksheets within the spreadsheet application. Based on the task for which the worksheet is designed, functionality of the worksheet is not only tailored to the function, but also constrained to focus user interaction on the task for which the spreadsheet is intended.

In one aspect, a computer-readable medium having computer-executable modules is provided. The medium includes a computer spreadsheet application including a worksheet defining a series of cells arranged in addressable rows and columns. In addition, a sheet definition is provided. The sheet definition includes a set of constraints applied to the worksheet based on a task-specific function defined for the spreadsheet. Users may select a task-specific worksheet in the application which is limited by the set of constraints.

In another aspect, a computer readable medium having computer-executable instructions for performing steps is provided. The steps include displaying a task-specific worksheet selection interface. When a user selects one of the worksheets, the instructions determine one or more constraints in the worksheet limiting a user ability to interact with the worksheet based on a task-specific function of the worksheet. The instructions display the task-specific constrained worksheet and receive a user interaction with the spreadsheet. When interaction is received, a determination is made as to whether the user interaction is allowed and if so, the interaction is performed. If the interaction is allowed, and the user interaction is constrained by the sheet, the interaction is constrained. If the interaction is not allowed, it is prevented.

The present technology can be accomplished using hardware, software, or a combination of both hardware and software. The software used for the present technology is stored on one or more processor readable storage media including hard disk drives, compact disc read-only memories (CD-ROMs), digital versatile discs (DVDs), optical disks, floppy disks, tape drives, random only memory (ROM), random access memory (RAM) or other suitable storage devices. In alternative embodiments, some or all of the software can be replaced by dedicated hardware including custom integrated circuits, gate arrays, field-programmable gate arrays (FPGAs), programmable logic devices (PLDs), and special purpose computers.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary system hardware configuration suitable for implementing an application in accordance with the present technology.

FIG. 2 is a flowchart illustrating a method for providing a task-specific constrained worksheet in accordance with the present technology.

FIG. 3 is a depiction of a user interface displaying worksheet selection interface.

FIG. 4 is a depiction of a user interface after the user has selected a task-specific worksheet in accordance with the present technology.

FIG. 5 is a depiction of data selection and population in a task-specific worksheet.

FIG. 6 depicts a contextual menu accessible via a formatting interface for inserting cell data into the worksheet.

FIG. 7 illustrates a populated pre-formatted cell group in accordance with the present technology.

### DETAILED DESCRIPTION

Function or task-specific worksheets are presented to the user by defining a set of constraints to a spreadsheet application worksheet. By limiting the user interaction with the sheet, increased functionality is provided to the user without requiring the user to know how to program the spreadsheet. User interaction can be limited in terms of both the format of the spreadsheet, the spreadsheet application functions available to the user, and the functionality of data input and selection of items in the cells.

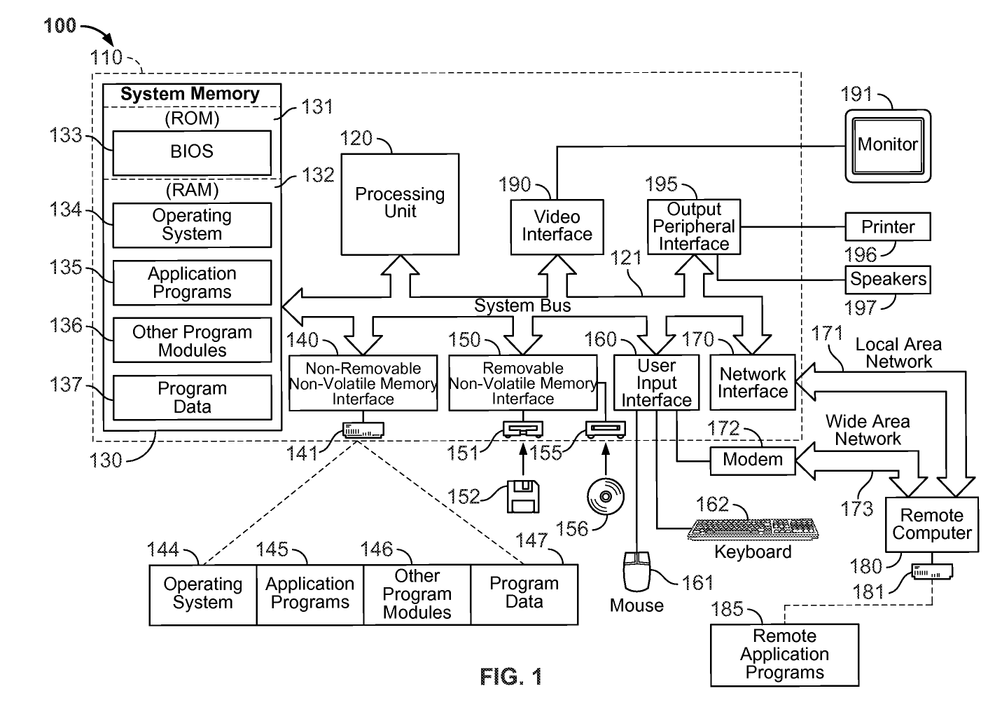

FIG. 1 illustrates an example of a suitable computing system environment 100 on which the technology may be implemented. The computing system environment 100 is only one example of a suitable computing environment and is not intended to suggest any limitation as to the scope of use or functionality of the technology. Neither should the computing system environment 100 be interpreted as having any dependency or requirement relating to any one or combination of components illustrated in the exemplary computing system environment 100.

The technology is operational with numerous other general purpose or special purpose computing system environments or configurations. Examples of well known computing systems, environments, and/or configurations that may be suitable for use with the technology include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

The technology may be described in the general context of computer-executable instructions, such as program modules, being executed by a computer. Generally, program modules include routines, programs, objects, components, data structures, etc. that perform particular tasks or implement particular abstract data types. The technology may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the technology includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, electrically erasable programmable read-only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Application programs 135 stored in system memory 130 may include a spreadsheet application program for performing the present technology as described hereinafter. The spreadsheet application program may additionally include all other functionality of conventional spreadsheet application programs such as for example Microsoft® Office Excel from Microsoft Corporation, Lotus® 1-2-3 from Lotus Software, and/or other spreadsheet application program. When the spreadsheet application program is launched, it runs on the operating system 134 while executing on the processing unit 120. An example of an operating system on which spreadsheet application program may run are the operating systems produced by Apple Computer, Inc., but the spreadsheet application program may be operate on a variety of operating systems including also the Windows® operating systems from Microsoft Corporation, or Linux operating systems. The spreadsheet application program may be loaded into the memory 130 from the optical disk drive 155, or alternatively, downloaded from over network 171 or 173.

Computing system environment 100 typically includes at least some form of computer readable media. Computer readable media can be any available media that can be accessed by computing system environment 100. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing system environment 100. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

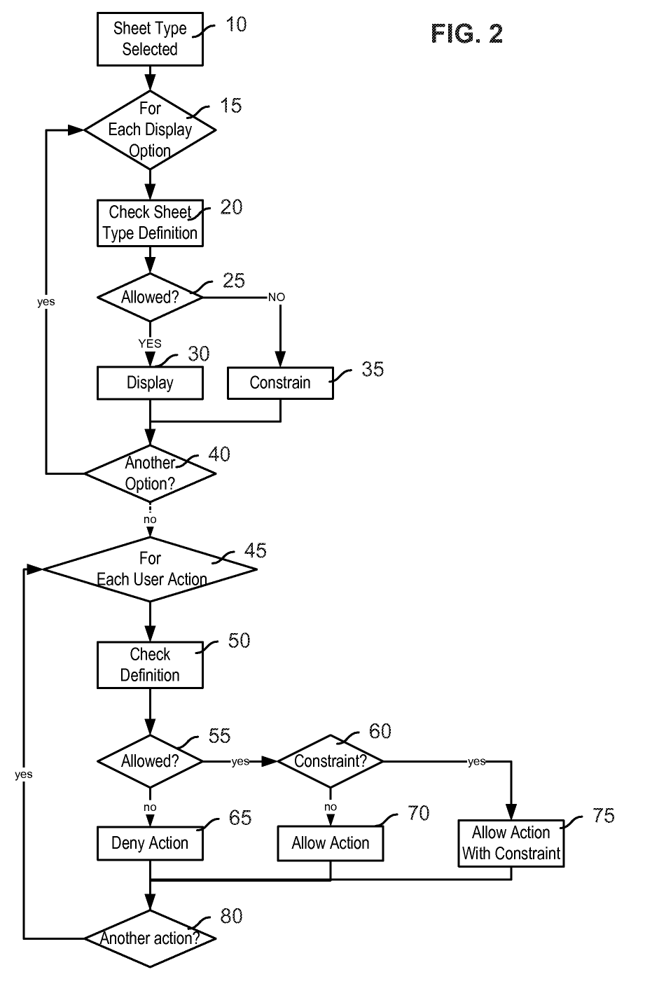

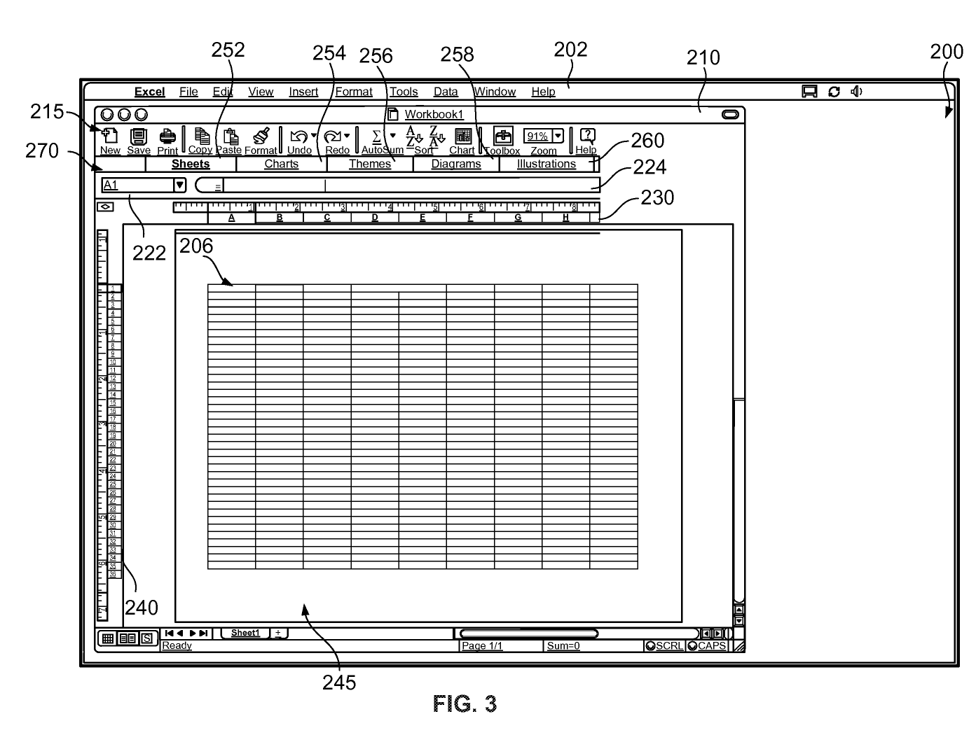

FIG. 2 is a flowchart depicting one aspect of the technology for providing task-specific worksheets based on sheet-types. FIG. 2 will be described with reference to the user interface depictions in FIGS. 3-7.

FIG. 3 is a depiction of a user interface for a spreadsheet application. The worksheet represented therein is a blank worksheet, devoid of data entry or cell relationship programming. The user interface is provided on computer screen 200 and interface includes a menu bar 202 having a number of standard commands available to a spreadsheet application such as File, Edit, View, Insert, Format, Tools, Data, Window and Help. It will be recognized that in alternative embodiments, the application interface need not require a menu bar.

The spreadsheet application program of the present technology may include some or all of the tools, functionality and features of Microsoft® Excel and/or other conventional spreadsheet application programs. Upon launching the spreadsheet application program, as shown in FIG. 3, a workbook window 210 which may include one or more worksheets 245 is presented. The worksheet 245 and a tool bar 215 for entering and managing information on graphical spreadsheet 245 are merely exemplary and may vary in accordance with the particular features of the application program. Worksheet 245 may consist of rows and columns of individual cells 206. The columns may be organized by letter—Columns A, B, C, etc.—and the rows may be organized by number—Rows 1, 2, 3, etc., although the column and row designations may be switched or represented otherwise in alternative embodiments. There may be more or fewer columns and rows than shown in FIG. 3. Each cell 206 may be identified by a combination of column letter and row number. Cell “B3,” for instance, may be in column B and row 3.

A spreadsheet interface includes a spreadsheet window 210 including a tool bar 215 having a number of standard menu item functions such as New (to create a new spreadsheet), Save (to save a spreadsheet), Print, Copy, Paste, Format, Undo, Redo, Auto send, Sorting, and other functions. Below tool bar 215 is a task selection bar 270 allowing the user to create items in the spreadsheet application by selecting links for task-specific sheets 252, charts 254, themes 256, diagrams 258 and illustrations 260. It will be recognized that the menu entries in the tool bar 215 and task selection bar 270 are merely exemplary. Also shown is a cell selector interface 222 and formula bar 224, which will be readily recognized by users of applications such as spreadsheets. A column indicator 230 and row indicator 240 are also provided to allow the user to easily assess the position of a cell selector in the spreadsheet.

In accordance with the present technology, a user may select to create task-specific worksheets designed for a particular purpose. As well known, a worksheet is a working area within a spreadsheet application containing contiguous rows and columns of potentially linked cells. A spreadsheet application may contain many worksheets and cells or groups of cells in a worksheet may be linked to cells in other worksheets.

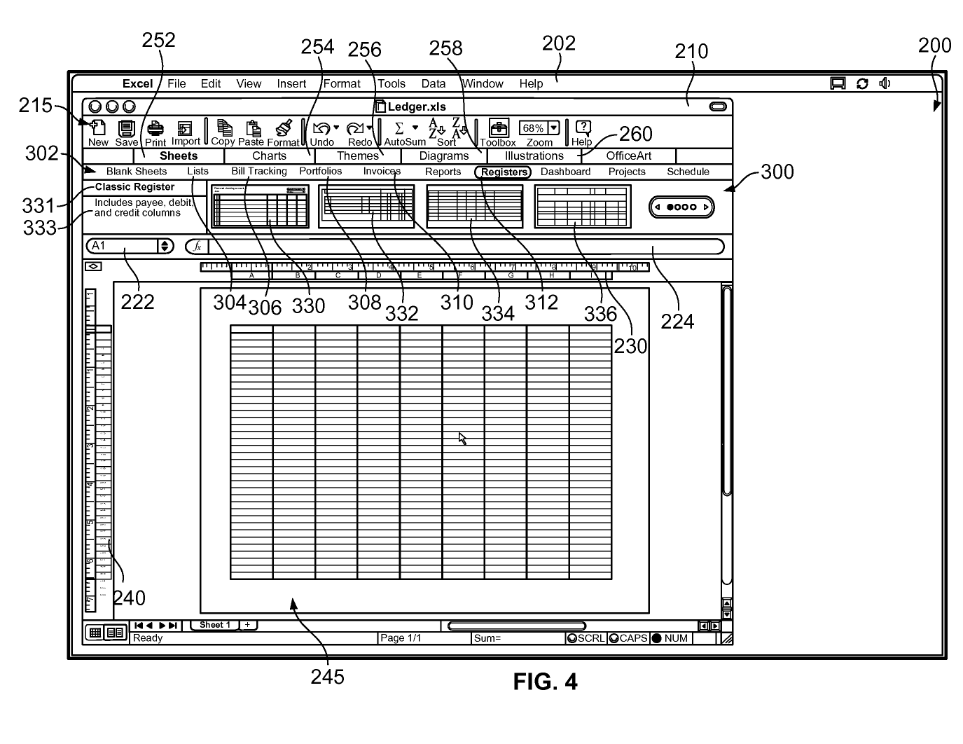

FIG. 4 shows an interface for selecting a task-specific worksheet in accordance with the present technology. In FIG. 3, when a user selects task-specific “sheets” menu item 252 from task selection bar 270, an elements gallery 300 is displayed as shown in FIG. 4. The elements gallery 300 exposes thumbnail views of task based spreadsheets 330, 332, 334, 336. Each task based sheet is a task-specific worksheet which is designed to allow a user to perform a specific function desired by the user. The gallery 300 includes a descriptor 331 and short description 333 of each selected or highlighted group of worksheets 330, 332, 334, 336. One or more groups may be provided.

Task selection bar 302 is a list of these groups organized into different categories. In this embodiment, the categories include financial tasks, Registers, Lists, Bill Tracking, Portfolios, Invoices, and Reports. Other types include a Dashboard sheet, a Projects (project tracking) sheet and a Schedule sheet. Selecting one of the items in this group will present a different thumb-nailed version (330, 332, 334, 336) of the task sheet in interface 300. It should be understood that the list of groups presented in FIG. 4 is exemplary.

As described herein, the Registers task-specific sheets are designed to hold a number of transactions, such as checkbook transactions, credit card transactions, and saving registers. Bill tracking task-specific sheets help users plan and budget upcoming expenses, and support previous and upcoming dealings. Lists task-specific sheets include business transaction lists, checks, payees, customers, services, and goods. Portfolios task-specific sheets include groups for tracking stocks, bonds, and retirement funds. Invoices sheets include service, retail and wholesale invoice groups that generally fall into two types: ledgers and mailers. Ledgers act as a flat invoice database file, while mailers will extract data from one invoice in a printer friendly format. Reports task-specific sheets include groups suitable for tracking monthly expenses, categorizing expenses, outstanding invoices, a customer statement and the like. Projects task-specific sheets may include spreadsheet objects designed to allow a user to track projects in a manner such as a Gantt chart. The Schedule task-specific sheets may provide date and time entry objects. The Dashboard task-specific sheets include collections of different data of the types described above to provide a single interface for the collections of objects. Other task-specific functions may include a text-entry worksheet, allowing users to enter text in one or more cells in a worksheet in a manner similar to a word processing program.

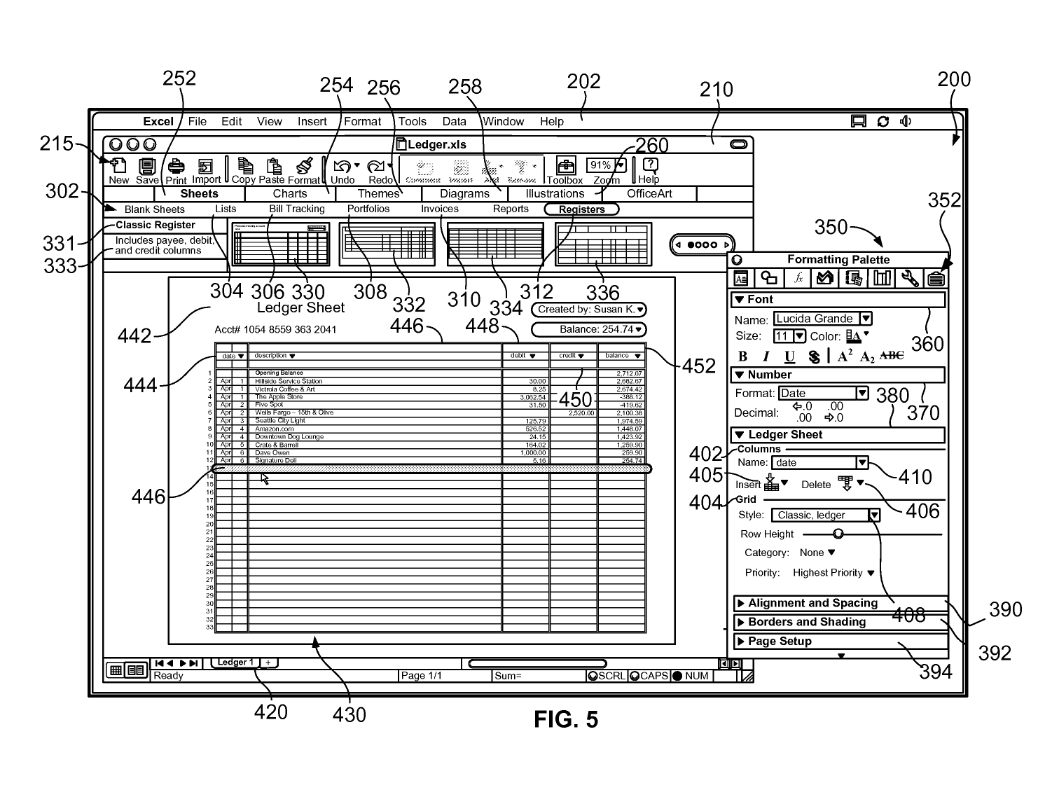

In FIG. 4, when a user selects one of the sheets icons 330, a display such as that shown in FIG. 5 is generated by the application. To select a sheet, the user may select the task sheet such as, by highlighting a thumbnail item and by striking the Enter key on keyboard 162 and/or by “double clicking” on the selected function in the library field thumbnail. “Double clicking” is the known process of two rapid actuations of the pointing device 161 while the graphical pointer on the graphical user interface located over the object being selected. A user may “click and drag” the function from the interface into the workspace. “Click and drag” refers to the known process of selecting an object with the pointing device by actuating the pointing device with the associated graphical pointer on the graphical user interface located over the object to be selected (gallery 300). Then, with the pointing device remaining in the actuated position, moving the selected object to the desired location on the graphical user interface, in this instance, the worksheet 245.

Task-specific sheets can be created using a number of alternative methods. As noted above, the sheet may be chosen by selecting a sheet from the elements gallery. Alternatively, one may open a task-specific sheet by clicking an “Add-a-sheet sheet” tab or by choosing the Insert:Sheet menu item. When a user selects a task-specific worksheet for use, the selected task-specific sheet will be inserted into the active workbook.

In FIG. 5, once the user has selected, for example, a group entitled “ledger sheet” 330, the interface and sheet is presented in the active worksheet 245.

Returning to FIG. 2, selection of a task-specific sheet at step 10 causes the application of the present technology to perform a rendering loop to determine, based on a sheet-type definition associated with the task-specific sheet selected, a set of constraints on the spreadsheet application that are associated with the task-specific sheet.

For each type of task-specific worksheet supported by the technology, a sheet-type definition will define a set of display and functional constraints in the spreadsheet application which are applied to the user interface of the application. The set of constraints may include, for example: which menu items or menu bars are allowed to be displayed; whether tabs for additional worksheets are displayed; how the formatting (fonts and styles) of the active worksheet appears; whether menu items are grayed out (and hence unavailable) to a user; the size of the worksheet; whether menu buttons on menu bars change; and the like.

As such, at step 15, for each possible display option, the sheet type definition is checked at step 20 and a determination made at step 25 whether the display option is allowed. If so, it is displayed at step 30 and if not, it is constrained in the manner defined in the sheet type definition at step 35. This follows for all possible display options available in the spreadsheet technology. For example, rulers, column and row headers are suppressed as are the formula creation tools in the tool bar 215—a comment button in FIG. 5 had replaced the auto-sum button shown in FIG. 4. As illustrated at 446, the task-specific sheet “ledger sheet” employs a row-wide selection model and sheet-specific copy-paste rules. When a user is working with a task-specific sheet, the constraints tailor the sheet to meet the task-based need of the user.

Returning to FIG. 5, a first exemplary task-specific sheet 430 is shown. The task sheet 430 shown in FIG. 5 offers a streamlined creation of a financial management spreadsheet built on the needs of the home and small business user.

In the example shown in FIG. 5, a checkbook will generally require a date, check number, description, debit/credit and balance columns. Note that the task-specific sheets may include one or more preformatted cell groups such as those described in U.S. patent application Ser. No. 11/153,504, entitled “PRE-FORMULATED SPREADSHEET CELL GROUPS,” inventor Stuart N. DeSpain, assigned to the assignee of the present application and hereby incorporated fully by reference.

Pre-formulated cell groups (PCGs) are groups of interrelated cells having knowledge in terms of context and relationships about other groups and columns in the cell group. Each pre-formulated cell group has an identity and associated functions, formulas and/or layout. While some programs like databases can associate types of data to a column, each PCG carries with it an understanding of the data's context. The balance column for example, knows it must carry with it a debit and credit column in order to function. Contextually the PCG is a basic financial management condition.

Once created, the use of the task-specific sheet is constrained as illustrated in FIG. 2. For each user action 45, the sheet-type definition will be checked at step 50 to determine at step 55 whether the action is allowed. If not, the action is denied at step 65. For example, if the user attempts to insert a blank column between two columns (adjacent debit and credit columns of a checkbook, for example) the sheet-type may prevent insertion of the undefined column. If the action is allowed at step 55, the application will determine whether it is constrained at step 60. Using the above example, column insertion may be allowed, but only at certain locations in the worksheet. If the action is not constrained, it is allowed at step 70. If allowed with constraint and the constraint is met, the action is allowed in its constrained form at step 75.

FIG. 5 is a depiction of the personal checking account ledger sheet 420 with data populated for the user generating the sheet. In FIG. 5, the task-specific sheet 430 has a heading 442, and includes a date column 444, description column 446, debit column 448, credit column 450, and balance column 452 designed to act as a user's personal checking account checkbook.

Also shown in FIG. 5 is formatting palette 350. The formatting palette 350 is provided by the spreadsheet application user interface engine and includes a task selection toolbar 352, a font sub menu 360, a number sub menu 370, a Task Sheet (Ledger sheet) 380 sub menu, and an alignment and spacing sub menu 390, borders and shading sub menu 392 and a page set-up sub menu 394. The formatting palette is an interface to allow the user to modify elements of the task sheet and includes a number of sub-menus.

In FIG. 5, the font sub menu 360, number sub menu 370 and ledger sheet submenu 380 are open. A disclosure triangle may be presented next to the header of each menu such that, if clicked, collapses or expands each menu as is well known in the art. The disclosure triangle may be omitted in alternative embodiments. The number sub menu 370 affects the number format for an entire column, while the font sub menu affects the font characteristics for a known column or range. Each is constrained by the sheet-type definition and, in alternative embodiments of different sheet types, may be suppressed.

Each task-specific sheet includes one or more programmed relationships (by means of direct programming of the relationships or though the use of pre-formatted cell groups) that maintains a relationship of its rows, range or columns with respect to one another. In the menu “ledger sheet” 380, this includes, for example, the kind of number formatting which should be applied to the date and check number columns that the description field is a text field, and that adding any credits and subtracting any debits determines the balance. This knowledge allows a programmatically determined formula to determine the results of the balance column. In addition, knowing that a workbook has a checkbook, a layout can be predetermined for the user.

In addition, elements of the interface may be changed to prevent the user from modifying the task sheet in a manner that would destroy the functionality of the group.

Other changes are not as visible. For instance, if the user pastes data, it will be strictly mapped to the destination. The date column will force dates to be shown, while the debit column will only show numbers with two decimal places. Column interaction is also modified, in that Ledgers always try to fit to a single page width. Further, users are not able to enter formulas. Collectively, these changes help users focus on (in the this example) managing their checkbook.

As also shown in FIG. 5, formatting palette 350 now has a task (or “ledger”) sheet sub-menu 380 open. The sheet sub-menu 380 includes a column sub menu 402 and a grid sub-menu 404. The column sub menu 402 allows the user to determine the name 410 of a particular column and includes an add function menu 405 and a remove function menu 406, each of which may provide additional menus or interfaces, such as a context sensitive submenu shown below, to allow adding or removing object (cells, rows, images, blocks, data, etc) based on the defined constraints. It should be noted that the task sheet submenu may change based on the sheet selected. That is, various options in the task (ledger) sheet sub-menu may change based on the sheet selected.

The add button 405 allows users to add objects such as cell groups mapping to specific sheet types. In one case, this may be rows and columns, but objects may also include groups of cells, PCGs, images, data, or any of a number of other types of objects.

In one embodiment, the user enters data into the spreadsheet in a manner like that of any spreadsheet by typing information into cells allowing input (such as date, description, debit and credit—balance is calculated from debit and credit data). As illustrated in FIG. 5, selection in a task-specific sheet will be controlled by the sheet-type. In FIG. 5, selection is limited to an entire row of data as illustrated at reference number 446. The type of data which may be input to the task-specific sheet is also governed by the sheet type, which may include one or more PCGs which may themselves govern input.

In one embodiment, the sheet-type requires a task-specific sheet to default to certain view, such as a Page Layout View (single page zoom) for a friendlier first-time experience. Another option includes setting the rulers, row/column headers, and the formula bar all “off” so users can focus on the task(s) at hand. In this embodiment, users may be prevented from displaying the rulers, row/column headers and the formula bar by the sheet-type definition. Input from the enter, tab, and return keys can be constrained to stay within the confines of the sheet. It will be noted that each of the aforementioned options can be sheet-type specific—some types may define the options such as the formula bar, etc, as always off, while others some might just have such options initially turned off, and still others may have them always on and not allowed to be turned off.

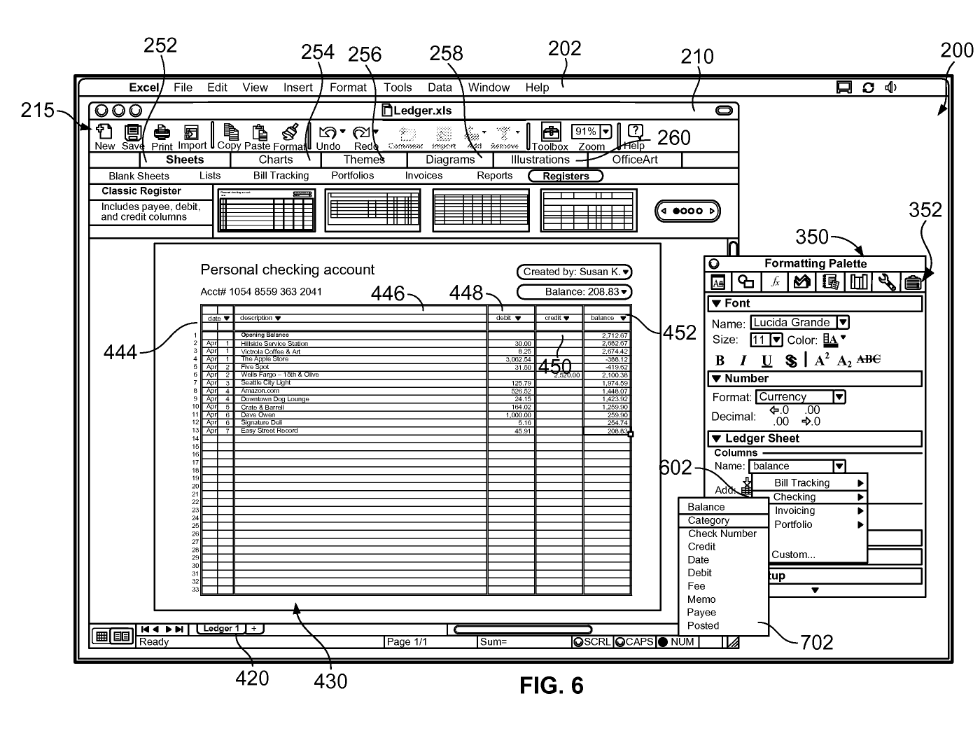

FIG. 6 illustrates the selection of the add control at 602. The Formatting Palette 350 can be constrained to allow only special sections with easy access to Ledger functionality. In FIG. 6, the user makes the selection from the formatting palette 350 of the add column tool 602. Selection of the add control 602 allows insertion of columns or PCGs in accordance with certain rules of the sheet-type. The user may remove columns by selecting the delete column button 406 (FIG. 5) from the format palette 350.

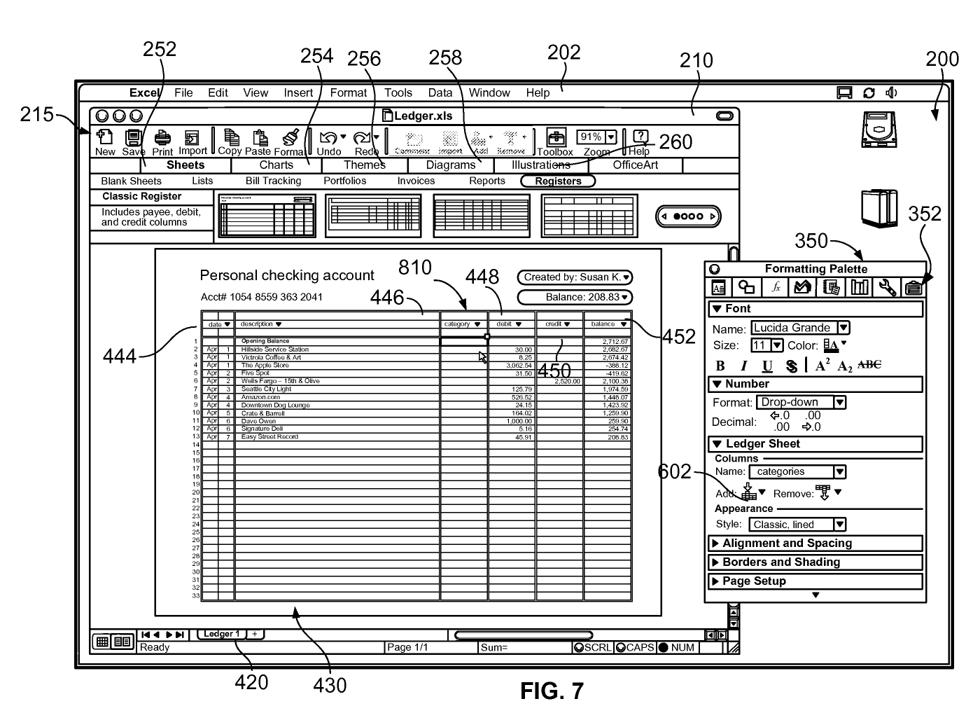

FIG. 7 shows the addition of the category column 810 as a result of the selection of this menu item in FIG. 6. In this example, the category column is a PCG having a preferred placement location relative to other PCGs in the active sheet.

In accordance with the technology, function or task-specific worksheets are presented to the user by defining a set of constraints to a spreadsheet application worksheet. By limiting the user interaction with the sheet, increased functionality is provided to the user without requiring the user to know how to program the spreadsheet.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-readable medium having computer-executable modules comprising:
(a) a computer spreadsheet application including a worksheet defining a series of cells arranged in addressable rows and columns; and
(b) a sheet definition comprising a set of constraints applied to the worksheet based on a task-specific function defined for the spreadsheet.

2. The computer readable medium of claim 1 wherein said set of constraints limits one or more data entry features in the worksheet.

3. The computer readable medium of claim 1 wherein said set of constraints limits one or more formatting features in the worksheet.

4. The computer readable medium of claim 1 wherein the sheet definition includes at least one an embedded function for a series of cells relative to other cells in the spreadsheet.

5. The computer readable medium of claim 1 wherein the sheet definition defines a set of constraints for a ledger sheet.

6. The computer readable medium of claim 1 wherein the sheet definition defines a set of constraints for a project tracking sheet.

7. The computer readable medium of claim 1 wherein the sheet definition defines a set of constraints for a scheduling sheet.

8. The computer readable medium of claim 1 wherein the sheet definition defines a set of constraints for a dashboard sheet comprising data from one or more of a ledger sheet, a scheduling sheet, a text entry sheet and a project tracking sheet.

9. A computer readable medium having computer-executable instructions for performing steps comprising:
(a) displaying a worksheet having a plurality of cells arranged in rows and columns;
(b) displaying a selection interface to a user allowing the user to select a task-specific worksheet;
(c) responsive to a selection of one of said worksheets, determining one or more constraints in the worksheet limiting a user ability to interact with the worksheet based on a task-specific function of the worksheet; and
(d) displaying a task-specific constrained worksheet.

10. The computer readable medium of claim 9 wherein said step of displaying includes displaying a format constrained worksheet.

11. The computer readable medium of claim 9 wherein said step of displaying includes displaying a data-entry constrained worksheet.

12. The computer readable medium of claim 9 wherein said method further includes limiting functional controls in the spreadsheet application when displaying the task-specific constrained worksheet.

13. The computer readable medium of claim 9 wherein said method further includes limiting the type of data entry available to a user for at least one set of cells in the worksheet.

14. The computer readable medium of claim 9 wherein the method further includes limiting cell selection to a subset of cells.

15. A computer readable medium having computer-executable instructions for performing steps comprising:
(a) displaying a task-specific worksheet selection interface;
(b) responsive to a selection of one of said worksheets, determining one or more constraints in the worksheet limiting a user ability to interact with the worksheet based on a task-specific function of the worksheet;
(c) displaying a task-specific constrained worksheet;
(d) receiving a user interaction with the worksheet;
(e) determining whether the user interaction is allowed and if not, preventing the interaction; and
(f) determining whether the user interaction is constrained and if so constraining the interaction.

16. The method of claim 15 wherein said step of displaying includes limiting one or more application specific functions.

17. The computer readable medium of claim 15 wherein said step of displaying includes displaying a format constrained worksheet.

18. The computer readable medium of claim 15 wherein said method further includes limiting functional controls in the spreadsheet application when displaying the task-specific constrained worksheet.

19. The computer readable medium of claim 15 wherein said step (f) includes limiting the type of data entry available to a user for at least one set of cells in the worksheet.

20. The computer readable medium of claim 15 wherein said step (f) method further includes limiting cell selection to a subset of cells.
